(19) United States
(12) Patent Application Publication
(10) Pub. No.: US 2008/0208881 A1
(43) Pub. Date: Aug. 28, 2008

(54) METHOD AND APPARATUS FOR LOCAL INSERTION OF ADVERTION OF ADVERTISING MEDIA INTO A NETWORKED DIGITAL ADVERTISING SYSTEM

(76) Inventors: Kenneth James Boyle, Marietta, GA (US); Naveed Ashraf, Atlanta, GA (US)

Correspondence Address: Joseph J. Laks;Thomson Licensing LLC, 2 Independence Way, Patent Operations, PO Box 5312, PRINCETON, NJ, 08543, US

(21) Appl. No.: 11/903,292

(22) Filed: Sep. 21, 2007

Related U.S. Application Data
(60) Provisional application No. 60/904,066, filed on Feb. 28, 2007.

(51) Int. Cl. G06F 17/30

(52) U.S. Cl. 707/101; 707/E17.009

(57) ABSTRACT

A user, seeking to modify an established content play list will enter an alteration request specifying the desired alterations, which can include the deletion and/or addition of content as well as alteration of the content order. A user profile (127) authenticates the user to determine whether the user has the authority to alter the established play list and if so, for which subset of locations. Following user authentication, the established play list undergoes modification for the subset of locations for which the user is authorized to alter the content play list. In this way, a user can locally modify an established play list to add and/or alter content, based on that user's profile, without altering the content at other locations.

### CROSS-REFERENCE TO RELATED APPLICATIONS

This application claims priority under 35 U.S.C. 119(e) to U.S. Provisional Patent Application Ser. No. 60/904,066, filed Feb. 28, 2007, the teachings of which are incorporated herein.

### TECHNICAL FIELD

This invention relates to a technique for modifying media files in template and then the automated process of rendering a MPEG2 or MPEG 4 file and specifying the new files' placement with a play list.

### BACKGROUND ART

The term “Digital Signage Network” refers to a network arrangement of servers, players and display devices, and the interconnecting networks, for providing advertising and/or communications to various locations. Co-pending U.S. patent application Ser. No. 11/215,907, filed 31 Aug. 2005, (published 1 Mar. 2007 as Publication No. 20070050372A1) and incorporated by reference herein, describes system for creating, managing, and publishing advertisements throughout a digital signage network. As described in the '907 application, a user can input a request to the advertising publishing system to publish an advertisement in one or more media venues. After making the request, the user will select an advertisement for publication. Part of the user selection process can include selecting an existing advertisement and then making various changes, including those necessary to make the advertisement suitable for the intended media venue. The system reviews the user-selected advertisement for formatting. If the advertisement lacks the appropriate formatting; the system will notify the user who can then view the advertisement and revise or delete it as appropriate. Advertisements determined by the system to have the appropriate formatting will undergo rendering prior to scheduling for playout.

In many instances, a need exists to provide specific advertisement at one or more individual locations in place of, or in addition to the advertisements supplied generally to all the locations. For example, advertisements for goods and/or service specific to warm weather activities have much greater applicability in warm weather climates than to cold weather climates. Present day Digital Signage Networks do not readily allow the insertion of such local advertisements of full motion, MPEG2 or MPEG4 videos, making it difficult to tailor advertisements to a specific location while maintaining brand quality in a consistent manner.

Thus a need exists for a system that facilitates the insertion of local advertisements.

### BRIEF SUMMARY OF THE INVENTION

Briefly, in accordance with a preferred embodiment of the present principles, there is provided a method for modifying an established content play list, typically, remotely through the authenticated use of a web browser interface and by modifying a particular media file in the play list. The method commences from a user of at least one alteration to an established content play list for a subset of distribution locations. The established play list undergoes modification for the subset of locations pursuant to the at least one alteration received from the user following authentication of the user in accordance with a user profile In this way, a user can locally modify an established play list to add and/or alter content, based on that user's profile, without altering the content at other locations.

### BRIEF DESCRIPTION OF THE DRAWINGS

FIG. 1 depicts a block schematic diagram of a system, in accordance with the present principles for practicing a play list modification technique of the present principles;

FIG. 2 depicts a block schematic diagram of an advertising module comprising part of the system of FIG. 1; and

FIG. 3 depicts in flow chart form the steps of a process practiced by the system of FIG. 1 for modifying a play list.

### DETAILED DESCRIPTION

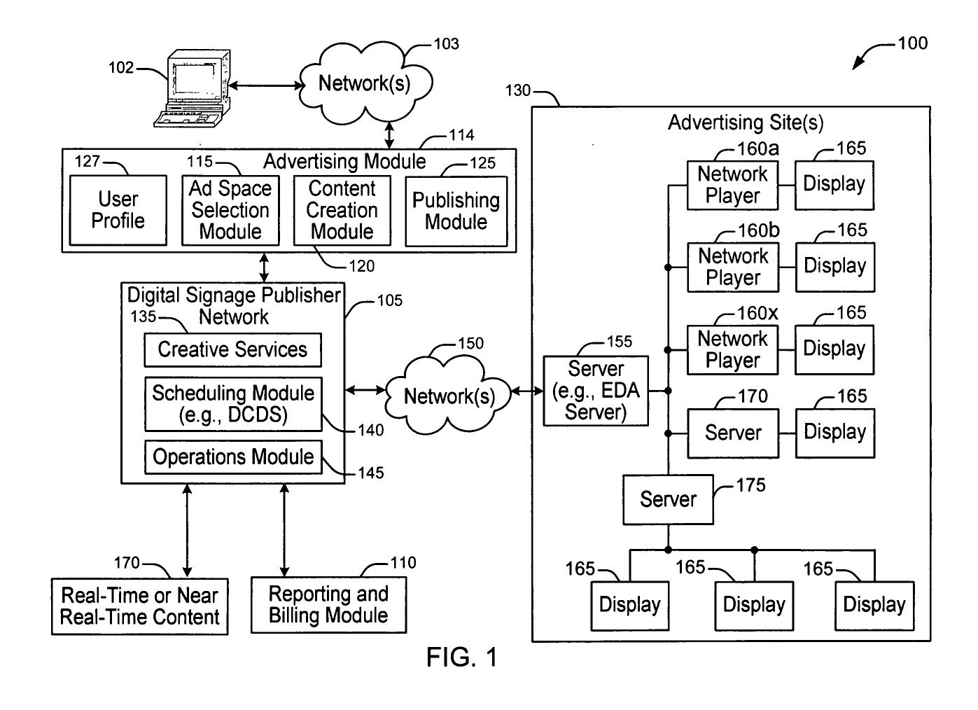

FIG. 1 shows a block diagram of a system 100 for enabling users to create and deliver content, such as advertising, while enabling the insertion of local content in place or in addition to general advertising in accordance with a preferred embodiment of the present principles. The system 100 includes at least one user computer 102 in communication with an advertising module 114 via one or more network(s) 103. The advertising module 114 typically includes a server (not shown) operable to run one or more software applications, and includes an ad space selection module 115, a content creation module 120, and a publishing module 125. Generally, the ad space selection module 115, content creation module 120, and publishing module 125 provide the user with web-based interfaces to enable a user, via the computer 102, to search and select ad space and to create, manage and publish digital content, including but not limited to advertisements. The subsequent reference herein to approval of ads should be understood to encompass the approval of other types of digital content as well.

The ad space selection module 115, content creation module 120, and publishing module 125 reside in computer software within the advertising module 114 and are accessible by a user via the computer 102 over the network(s) 103, which typically, although not necessarily encompasses the Internet. In such an embodiment, a user can communicate with the advertising module 114 using an Internet browser on the computer 102 that permits the user to view HTML pages, which are preferably displayed in graphical format. Well-known web browsers such as Netscape navigator and Microsoft Explorer automatically format data that is programmed in the HTML language according to well-known protocols. Information gets exchanged back and forth between the computer 102 and the advertising module 114 according to a well-known protocol, such as the Hyper-Text Transport Protocol (HTTP), although other protocols, such as FTP, are also available.

The computer 102 can exchange messages with one or one or more servers within the advertising module 114, which can include a web server and/or HTTP server. As is well known in the art, a web server can have installed files that include HTML documents or which can dynamically generate HTML documents for display on a screen of the computer 102. Thus, without the need for any hardware or software, other than a standard personal computer and a common web browser, a user can access the ad space selection module 115, content creation module 120, and publishing module 125 residing in computer software within the advertising module 114.

The computer 102 can include various standard components, including a central processing unit and associated read-only memory (ROM) (not shown), both of which are connected via a data and address bus to a random access memory (not shown). The computer 102 typically includes an input/output interface (I/O) and one or more I/O device(s) connected to the RAM, the CPU and the ROM via a bus. The CPU controls the I/O interface to control any corresponding I/O devices. Typical I/O devices can include a video display, a keyboard, a scanner, and a mouse or joystick or other input or output devices (all not shown). The computer 102 can also include one or more storage devices, which can comprise conventional devices for storing data, such an external hard disk. The computer 102 further includes a system for connection to the communications network(s) 103, such as a modem or a network interface card. The computer 102, as described, thus possesses the same elements as any typical personal computer capable of accessing a network, such as a WAN, LAN or the Internet.

In addition to the various hardware elements described above, the computer typically has an installed operating system, such as Microsoft Windows®, available from Microsoft, Redmond, Wash., or other well known operating system, that controls various software applications installed on the computer. Such applications can include programs for data management, storage and retrieval, a web browser application that is capable of formatting HTML documents, a communications program capable of controlling communications between the computer 102 and the network(s) 103.

As shown in FIG. 1, the advertising module 114 communicates with a digital signage publisher network 105, which can include creative services 135, a scheduling module 140, and an operations module 145. Generally, the digital signage publisher network possesses the capability of publishing advertisements created using the advertising module 114, whereas the scheduling module 140 serves to transmit such user-generated ads, created using the advertising module 114, to one or more advertising sites 130 via one or more networks 150. The advertisements can take the form of full motion, MPEG2 or MPEG4 videos. The scheduling module 140 controls the display of such user-created ads on the advertising sites 130 such that the ads undergo display based on the ad space purchased by the user via the ad space selection module 115. The scheduling module 140 further communicates in real-time or near real-time scheduling information to the advertising module 114, which includes ad space availability information. This permits the advertising module 114, and more specifically, the ad space selection module 115, to display up-to-date information detailing what ad space is available in the system 100.

The digital signage publisher network 105 can also include the operations module 145, which can include software and/or hardware for monitoring the status of user-generated ads playing (or having already completed playing) at one or more advertising sites 130. The operations module 145 can also include reporting and billing applications to bill users for ads played at advertising sites. The operations module 145 can communicate with a reporting and billing module 110, which can be used to automatically generate bills for payment by those using the system 100 to create and publish ads. It will be appreciated that because each ad space and/or user can correspond to different charges and/or rates, the operations module 145 should be operable to track billing for all advertisements played at any ad site. This can also be desirable for billing purposes should one or more ads be unplayable by the system 100 due, for instance, to an advertising site 130 being off-line or otherwise unavailable.

The digital signage publisher network 105 can also include a creative services unit 135, which can include professional editing personnel and/or software, and media (e.g., templates, backgrounds, pictures, and the like) that is used to aid in the publication of ads made by users using the advertising module 114. The creative services 135 unit can approve user-created ads prior to the scheduling module 140 forwarding the ads to advertising sites 130. This approval can be required not only for the content of the ads, but also for format, including length, size, file type, and the like. Additionally, creative services unit 135 might want to preview user created ads to ensure that they appear professionally formatted or rendered. Those skilled in the art will appreciate that the creative services unit 135 is optional

The system 100 shown in FIG. 1 also includes real-time or near real-time content 170. The real-time or near real-time content 170 can be transmitted to advertising sites 130 by the scheduling module 140 along with user-created ads. According to an aspect of the invention, the scheduling module 140 can transmit real-time or near real-time content 170 for display during gaps in the playing of ads. The real-time or near real-time content 170 can be inserted into ads, such that the ads include the real-time or near real-time content 170 along with stored content. As an illustrative example, a user wishing to advertise a product or service at a sporting venue, where the advertisement includes real-time streaming sports scores in a ticker-type display. Additionally, to ensure seamless integration of the real-time or near-real time content 170 with stored content, creative services 135 can be used to generate dynamic graphics that integrate the two digital media components.

As shown in FIG. 1, the digital signage publisher network 105 can be in communication with one or more media outlets, or advertising sites 130, via one or more networks 150, which can include satellite networks, cable networks, the Internet, local-area networks (LANs), or any other network capable of transmitting video and/or audio content to near or remote locations. According to one embodiment, the digital signage publisher network 105 can be located at a single facility and can transmit user-created ads to advertising sites 130. Through customization the content can be physically delivered through various mechanisms such as FTP(s), HTTP(s), pinnacle, VBase, Stratacache, satellite or terrestrial networks.

Each advertising site 130 can include a server 155, such as an EDA server, for receiving content provided by the digital signage publisher network. The server 155 distributes content, including user-generated ads to displays 165 via one or more network players 160a-160x and/or servers 170, 175, as is known in the art. The displays 165 can include Plasma, LCD, DLP, or CRT displays, or the like, located at an advertising site. Because each advertising site 130 only requires a single server, one or network players and one or more displays, each advertising site 130 can incur very little expenditure in setting up a digital advertising system. Additionally, because the scheduling of content, including user-generated ads, is managed by the scheduling module 140, very little setup or maintenance of the advertising site 130 is required.

As thus described, the system 100 possesses the elements of the media distribution system described in co-pending U.S. patent application Ser. No. 11/215,907, incorporated by reference herein. To facilitate user modification of an established play list to allow a local user to insert and/or alter content in accordance of the present principles, the advertising module 114 of the system 100 of FIG. 1 includes a user profile 127, typically taking the form of a database or a portion of a database that stores the identity of each user and an associated profile which specifies that user's permissions. In particular, the user permissions specifies the location(s) for which a user has permission to add and/or alter an established play. For example, USER_A, once authenticated could possess appropriate permissions add and/or alter an established play list for the advertising content played out at the location associated with network player 160a in FIG. 1. Another user, USER_B, once authenticated could possess the permission to add and/or alter an established play list for the advertising content played out at the location associated with the player 160x in FIG. 1. In this way, a user can accomplish the insertion of local advertisements of full motion, MPEG2 or MPEG4 videos, thus tailoring advertisements to a specific location while maintaining brand quality in a consistent manner.

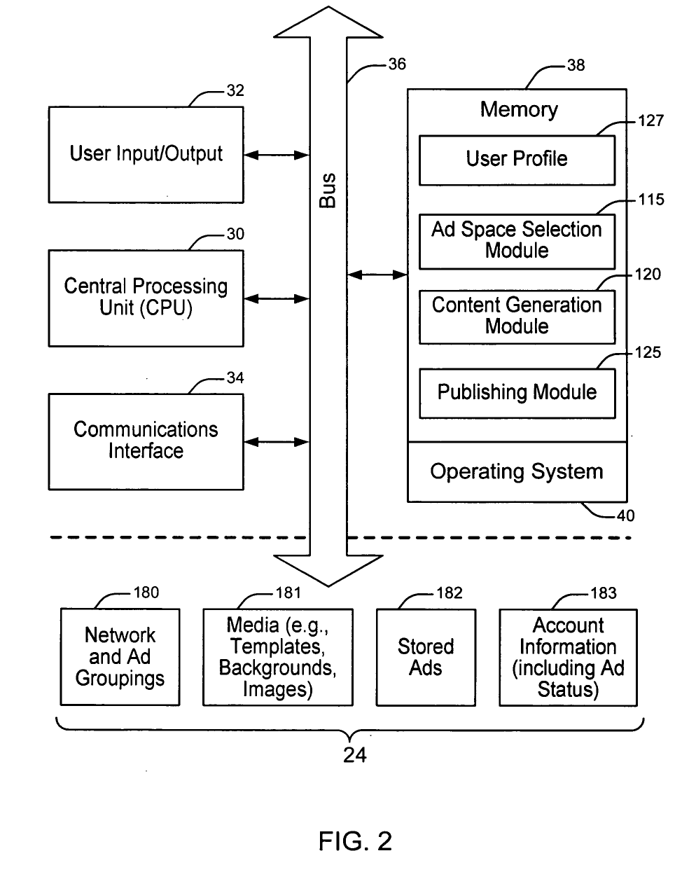

FIG. 2 shows a block diagram illustration of the advertising module 114, according to an exemplary embodiment of the present invention. As shown in FIG. 2, the advertising module 114 comprises a CPU 30, a User I/O 32, a communications interface 34 (for interfacing and communicating with other elements of a network), a Bus 36, a memory 38, an operating system 40, and a plurality of databases 24. A number of program modules can be stored by the memory 38, including the ad space selection module 115, the content creation module 120, the publishing module 125 and the user profile 127. Each of the program modules stored in memory 38 operate with the assistance of one or more CPUs and operating systems, such as the CPU 30 and the operating system 40.

Briefly, the ad space selection module 115 identifies the ad space available for purchase at the one or more advertising sites 130. The ad space selection module 115 provides search capabilities to permit a user to identify one or more advertising sites based on geographic location. Using the ad space selection module 115 the user can also select one or more time sensitive ad groupings. For instance, the user can select to advertise at a particular ad site every other month by purchasing monthly ad groupings for only the months the user would like to advertise. According to an aspect of the invention, the identity of advertising sites can be stored local to the advertising module 114, although it should be appreciated that ad space availability for such sites, or the identification of advertising sites, can be provided by the scheduling module 140.

The content creation module 120 permits a user to create new ads or to revise previously created ads. Ads can be created using stored media, which can include ad templates, backgrounds, images, video clips, audio clips, or the like. The content creation module 120 also permits a user to upload media for use in generating an ad, and permits a user to upload an entire ad. The content creation module 120 can also include a list of all ads associated with a user, which can be stored ads that are associated with a user account stored by the advertising module 114.

The publishing module 125 permits the review and approval of ads prior to their publishing, which can include the display of the ads at the advertising sites selected by the user via the ad space selection module. According to an aspect of the invention, the user can view the approval status of each ad. It will also be appreciated that four illustrative databases are shown in FIG. 2, including a networks and ad groupings database 180, media database 181, stored ads database 182, and an account information database 183. However, it will be appreciated by those of skill in the art that additional databases can exist for implementing the functions of the system 100 as described herein, and that one or more of the databases can be optional where the information (e.g., available networks and ad groupings) are provided by another component of the system 100.

The memory 38 in which the modules 115, 120, 125 and 127 reside can comprise random access memory, read-only memory, a hard disk drive, a floppy disk drive, a CD or DVD Rom drive, or optical disk drive, for storing information on various computer-readable media, such as a hard disk, a removable magnetic disk, a CD or DVD ROM disk, or the like. Likewise, the databases 24 can also comprise such computer-readable media. As will be appreciated by one of ordinary skill in the art, each of the modules 115, 120, 125 and 127 are connected to the bus 36 by an appropriate interface. The modules and databases and their associated computer-readable media provide nonvolatile storage for the advertising module 114. However, it is important to note that the computer-readable media described above could be replaced by any other type of computer-readable media known in the art. It will further be appreciated by one of ordinary skill in the art that one or more of the advertising module 114 components can be located geographically remotely from other advertising module 114 components. Furthermore, one or more of the components can be combined, and additional components performing functions described herein can be included in the advertising module 114.

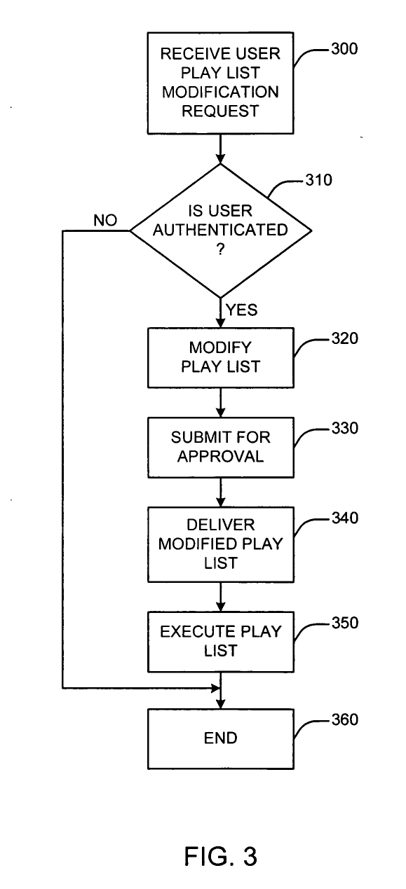

FIG. 3 depicts in flow chart form the steps of a process in accordance with the present principles that enables a local user to modify an established a play list that specifies content for playout. The process commences at step 300 upon receipt of a user provided play list modification request during step 300. The play list modification request typically originates from a local user seeking to modify an established, i.e., previously created play list, to alter the content played at a subset of locations, i.e., a lesser number than all of the locations where content playout would occur. In other words, the user seeks to modify play out of content at some, but not all locations.

The user modification request received during step 300 can include a command to alter a play list by deleting one or more existing advertisements. In addition to, or in place of a command to delete one or more existing advertisements, the user modification request could seek to change the order of advertising presentation. Further, alteration of the play list could also include the addition of one or more advertisements created using the system 100 in the manner discussed above. In other words, the user play list modification request can include new content, as well as a request to alter existing content. Thus, a user can seek to add and/or delete advertisements as well as alter the order of advertising playback.

To create content, the authorized user engages the system 100 using a web browser based application and selects from a series of creative templates. The user's choice of the templates will depend on the user's permissions. The system 100 maintains the media formats and playback business rules. The creative template(s) used in the creation of the media can employ different media forms within the same template, so templates can be assembled with different content clips. These media forms can comprise Standard Definition Video, High Definition Video, Graphics (JPEG, BMP), text and mono or stereo audio. Thus, a user can produce full motion broadcast MPEG 2 quality media for distribution.

Following receipt of the user play list modification request, the user undergoes authentication during step 310 via the user authentication profile 127 of FIGS. 1 and 2. In other words, upon receipt of the user's play list modification request, the user profile 127 will determine if the user possesses the authority to modify an established play list, and if so for what locations. If the user lacks the appropriate credentials, or seeks to modify a play list for a location for which the user lacks authorization, the authentication process fails, and the process ends at step 360.

Upon successful authentication during step 310, then step 320 undergoes execution and the play list gets modified for a set of user-specified locations in accordance with the user-request for modification. In this way, the user can add and/or alter the play list for one or more locations in the set for which the user possesses authentication. As discussed, the locations for which a given user possesses the authority to modify the established play list will comprise a subset of the locations where content delivery occurs. In the event the user seeks to add content, the added content automatically gets placed into the associated play-list for playback, eliminating the heed for further operator or user intervention at either the remote/local site or at the central distribution hub.

Following play list modification during step 320, the play list modification undergoes submission for approval during step 330. Assuming approval, then delivery of the modified play occurs to the set of user-specified locations during step 340. Although not depicted in FIG. 3, a lack of approval could result in termination of the process during step 360. Alternatively, a lack of approval could trigger transmission of a message to the user to enter a revised play list modification request. Although providing for approval prior to play list delivery is preferable, step 330 could be eliminated if desired. Once play list delivery has occurred, then execution of the modified play list occurs during step 350 after which the process ends at step 360

The fore going describes a technique that enables the distribution of content by allowing an authorized user, through a web interface, to modify and established play list. In this way, a user can create and schedule specific media for playback at a specific site or sites, based on the user authorization profile. The value of this technique lies in its ability to automate the play list modification, as well as creation of content, such as video files and distribute them to the screen/player of choice by a user outside of the creative/design/distribution group enabling the decentralization of content creation and distribution. This benefit means processing has to occur offline which results in a short delay before the file is ready for distribution as opposed to lower resolution mechanisms such as jpg/Flash. Another variant of an implementation of the present principles would be within a Television Broadcast Network where local media in inserted at the cable or local network station.

1. A method, comprising the steps of
receiving from a user at least one alteration request to modify an established content play list for a subset of distribution locations; and
modifying the established content play list for the subset of locations pursuant to the at least one alteration request received from the user following authentication of the user in accordance with a user profile.

2. The method according to claim 1 wherein the modifying step includes the step of deleting at least one piece of content from the content play list.

3. The method according to claim 1 wherein the modifying step includes the step of adding at least one piece of content to the play list.

4. The method according to claim 1 wherein the modifying step includes the step of altering content order in the content play list.

5. The method according to claim 1 further including the step of approving the user alteration request prior to modifying the established content play list.

6. The method according to claim 1 further including the steps of:
delivering the modified content play list to the subset of distribution locations; and
executing the modified content play list at the subset of distribution locations.

7. A method, comprising the steps of:
authorizing a user, in accordance with a user authorization profile, to modify an established content play list specifying content for playback; and
distributing the established content play list, as modified by the user, to a subset of established play list content distribution locations in accordance with the user authorization profile.

8. The method according to claim 7 wherein the established play list is modified by deleting at least one piece of content from the content play list.

9. The method according to claim 7 wherein the established play list is modified by adding at least one piece of content to the play list.

10. The method according to claim 7 wherein the established play list is modified by altering content order in the content play list.

11. The method according to claim 7 further including the step of approving the user alteration request prior to modification of the established content play list.

12. The method according to claim 7 further including the step of executing the established content play list as modified.

13. Apparatus, comprising:
an interface receiving from a user at least one alteration request to modify an established content play list;
a user profile store for receiving the alteration request and for authenticating the user; and
means for modifying the established content play list for a subset of locations established in accordance with authentication of the user by the user profile store.

14. The apparatus according to claim 13 wherein user profile store comprises a database storing a list of authorized users and corresponding location subsets for which the user is authorized to alter established content play lists.
